(19) United States
(12) Patent Application Publication
(10) Pub. No.: US 2004/0139944 A1
(43) Pub. Date: Jul. 22, 2004

(54) Method and device for controlling fuel injection in the bi-fuel internal combustion engine

(75) Inventors: Yasuyuki Nakano, Chiyoda-ku (JP); Masami Nagano, Chiyoda-ku (JP); Matsuo Amano, Chiyoda-ku (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd.

(21) Appl. No.: 10/749,551

(22) Filed: Jan. 2, 2004

(30) Foreign Application Priority Data
Jan. 6, 2003 (JP) 2003 000047

(51) Int. Cl. F02P 5/00; F02M 51/00; F02M 21/02

(52) U.S. Cl. 123/406.47; 123/478; 123/525; 123/576

(57) ABSTRACT

A bi-fuel internal combustion engine is intended for suppressing consumption of gasoline fuel and reducing exhaust emissions; under ordinary operations, a CNG fuel emitting smaller amounts of NOx, HC, CO, and the like as compared with a gasoline fuel, is used as a supply fuel to reduce the exhaust emissions; in this case, a fuel injection device is required for each of the two types of fuel, that is, the gasoline fuel and the CNG fuel and the problem is torque change and fluctuation occurring when the fuel is switched from gasoline to CNG, or vice versa.

Control is provided for correcting a fuel injection quantity, an intake air quantity, and ignition timing when the type of fuel supplied to the engine is switched from one type to another. A single fuel injector is used as both an injector of gasiform fuel and an injector of liquid fuel.

### BACKGROUND OF THE INVENTION

The present invention relates to an internal combustion engine for the so-called bi-fuel engine vehicle operating on two types or a plurality of types of fuel, such as gasoline and a compressed natural gas (CNG), and more particularly, to a fuel injection device for the internal combustion engine.

The bi-fuel internal combustion engine is intended for suppressing consumption of gasoline fuel and, for that matter, reducing exhaust emissions. A combination of gasoline and compressed natural gas (CNG) is a typical fuel used in the bi-fuel engine as disclosed, for example, in Japanese Patent Laid-open No. 2002-38986.

Under ordinary operations, a CNG fuel that emits smaller amounts of NOx, HC, CO, and the like as compared with a gasoline fuel, is used as a supply fuel to reduce the exhaust emissions.

In this case, a fuel injection device is required for each of the two types of fuel, that is, the gasoline fuel and the CNG fuel. Hence, two fuel injection devices are provided for a single internal combustion engine.

In the bi-fuel internal combustion engine capable of operating on both a gasiform fuel and a liquid fuel, it is necessary to prevent torque change and fluctuation encountered when the type of fuel supplied to the internal combustion engine is changed.

In addition, unlike the conventional gasoline engine, two fuel injection devices are provided for a single internal combustion engine, one for the gasiform fuel and the other for the liquid fuel. This results in increased cost of a fuel supply system. There is therefore a need for reducing the cost of the fuel injection control device.

### SUMMARY OF THE INVENTION

It is therefore an object of the present invention to suppress the torque change and fluctuation encountered when the type of fuel is switched. It is another object of the present invention to integrate and share components making up the fuel injection device.

To achieve the foregoing objects, one aspect of the present invention avoids the aforementioned problem by providing control for correction of a fuel injection quantity, correction of an intake air quantity, and correction of an ignition timing when the type of fuel supplied to the internal combustion engine is switched from the gasiform fuel to the liquid fuel, or vice versa.

Another aspect of the present invention is characterized in that a single fuel injector is used as both an injector of gasiform fuel and an injector of liquid fuel. This allows two fuel injectors provided conventionally for the gasiform fuel and the liquid fuel for each cylinder to be integrated into a single fuel injector. In addition, a fuel gallery can also be integrated into one type.

### DETAILED DESCRIPTION OF THE DRAWINGS

Other objects and advantages of the invention will become apparent from the following description of embodiments with reference to the accompanying drawings in which:

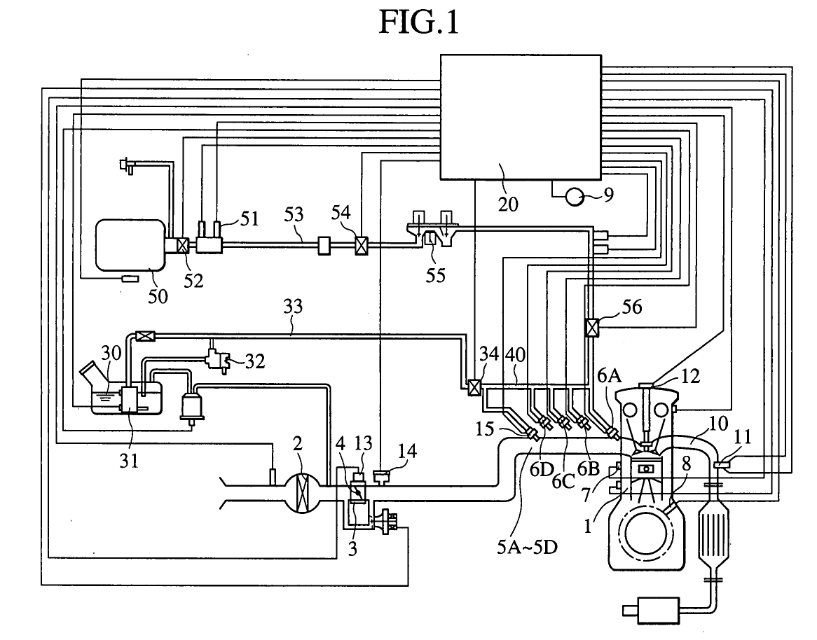

FIG. 1 is a diagram showing the construction of a system to which the present invention is applied;

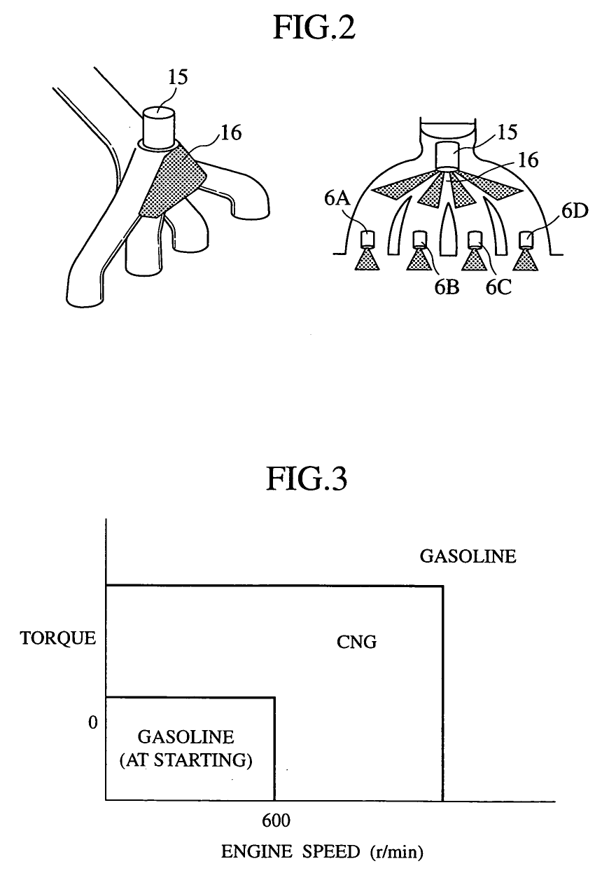

FIG. 2, including two views, illustrates a state where a common injector and a gasiform fuel-dedicated injector are installed;

FIG. 3 is a diagram showing timing at which the fuel is switched from one type to another relative to the engine speed;

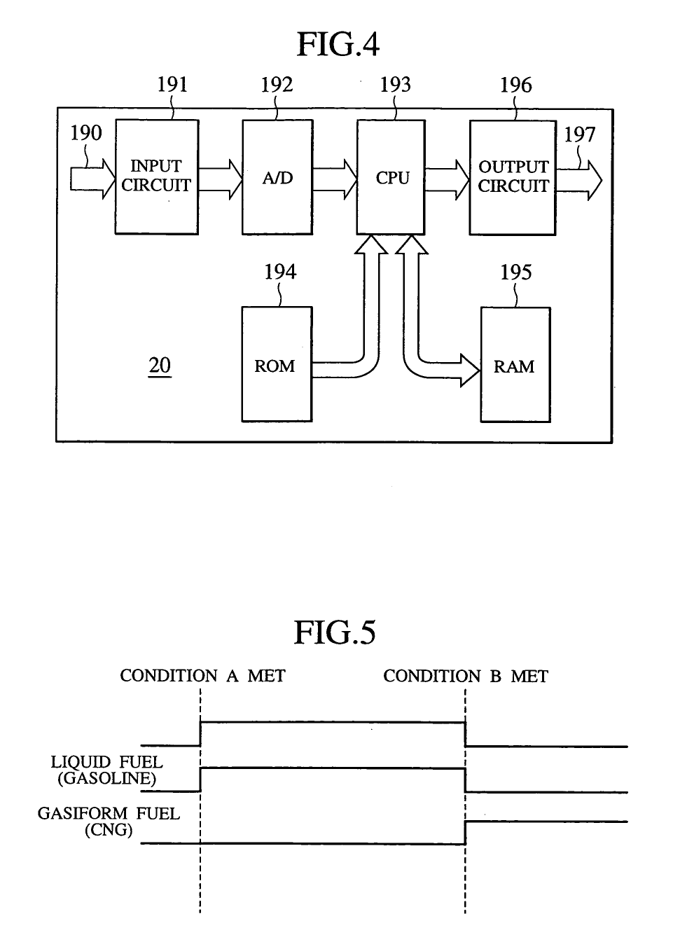

FIG. 4 is a block diagram showing the construction of a controller;

FIG. 5 is a diagram showing operations of the gasiform fuel injection device and the liquid fuel injection device as selected under specific conditions;

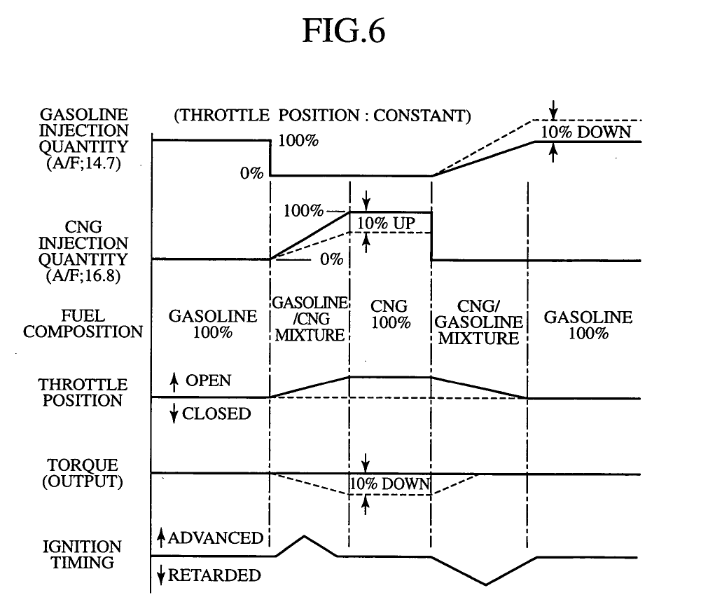

FIG. 6 is a diagram showing corrections made for the injection quantity, the throttle position, and the ignition timing at the changeover of the fuel from one type to another; and

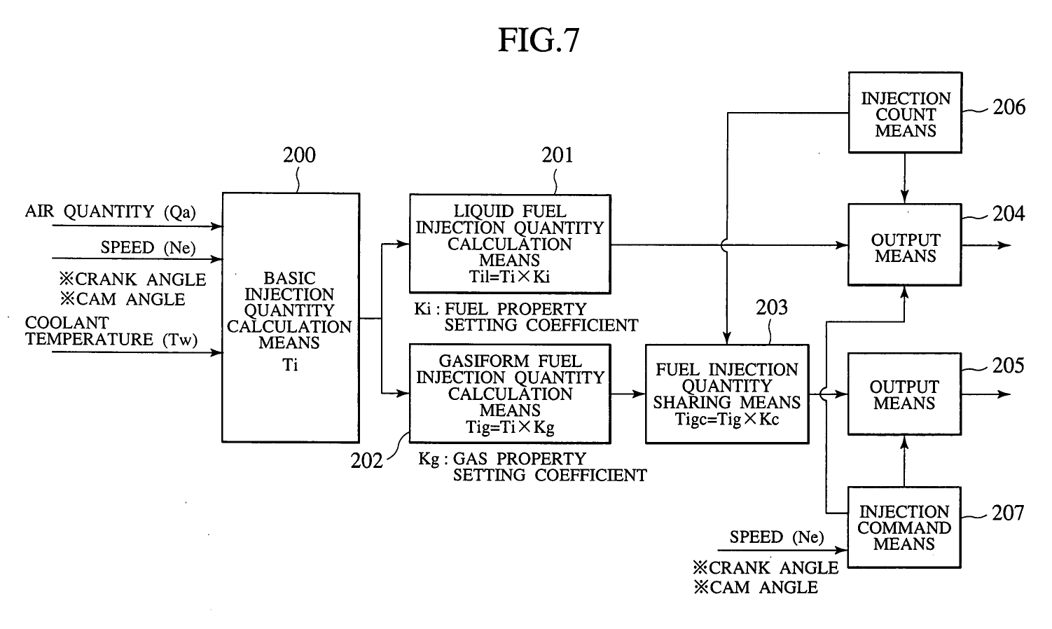

FIG. 7 is a control block diagram.

### DETAILED DESCRIPTION OF THE PREFERRED EMBODIMENTS

Preferred embodiments of the present invention will be explained with reference to the accompanying drawings. FIG. 1 is a diagram showing the construction of a system to which the present invention is applied.

FIG. 1 is a diagram showing the construction of a fuel injection system to which the present invention is applied. Gasiform and liquid fuel injectors 6A to 6D for injecting fuel are disposed for intake pipes 5A to 5D, respectively. A throttle body 3 is disposed upstream of the injectors. A throttle valve 4 is housed in the throttle body 3. A throttle position sensor 13 and an intake pipe vacuum sensor 14 are disposed for detecting a load condition of an internal combustion engine 1.

Each gasiform and liquid fuel injectors 6A to 6D is constructed such that it introduces fuel from an upper portion thereof and injects fuel from an orifice provided on a distal end thereof. The fuel is metered for injection by a movable valve that is moved up or down by an electromagnetic force and the orifice provided in a nozzle.

There are no specific restrictions imposed on the number of cylinders provided for the internal combustion engine 1. The description that follows assumes that four cylinders are provided for the engine 1 as a typical engine configuration. Air is drawn in through a duct not shown and passes through an air cleaner 2, the throttle valve 4 built into the throttle body 3, and the intake pipes 5A to 5D before being supplied to the internal combustion engine 1.

A liquid fuel injection device and a gasiform fuel injection device will be briefly described below.

The liquid fuel injection device works as follows: A fuel pump 31 disposed in a fuel tank 30 sends fuel under pressure to a liquid fuel pipe 33. A liquid fuel pressure regulator 32 controls the pressure of the fuel to a predetermined fuel pressure value. The fuel then moves past a fuel gallery 40 and is injected to the intake pipes 5A to 5D from the gasiform and liquid fuel injectors 6A to 6D. Switching to the gasiform fuel is accomplished by opening a safety cutoff valve 52, a high pressure cutoff valve 54, and a gasiform fuel cutoff valve 56 with a liquid fuel cutoff valve 34 closed.

The gasiform fuel injection device works as follows: The gasiform fuel is sent from a high pressure cylinder 50 filled with the gasiform fuel under high pressure. The gasiform fuel then moves past a fuel pressure sensor 51, the safety cutoff valve 52 opening or closing a path for the gasiform fuel, and a gasiform fuel pipe 53 mounted with a gasiform fuel pressure regulator 55. The gasiform fuel then moves past the fuel gallery 40 and is injected to each of the intake pipes 5A to 5D from each of the gasiform and liquid fuel injectors 6A to 6D mounted on the respective intake pipes 5A to 5D. The safety cutoff valve 52 releases or cuts off gas in accordance with operation or stop of the internal combustion engine 1. The gasiform fuel pressure regulator 55 regulates a pressure differential relative to a pressure of intake pipe downstream of the throttle body 3 to a given level. Switching to the liquid fuel is accomplished by closing the safety cutoff valve 52, the high pressure cutoff valve 54, and the gasiform fuel cutoff valve 56, while opening the liquid fuel cutoff valve 34.

FIG. 2 is a view showing a fuel injection device according to the embodiment of the present invention. The gasiform and liquid fuel injectors 6A to 6D used commonly for gasiform fuel and liquid fuel are disposed in the corresponding intake pipes for the respective cylinders. A specific type of fuel is selected according to an engine operating range, or an engine speed. FIG. 3 shows an example of timing at which the fuel is switched from one type to another relative to the engine speed. The liquid fuel having a high energy density is used during starting, especially at cold starts, and in a high rpm range. The gasiform fuel is used in low and medium rpm ranges. One injector 15 dedicated to the gasiform fuel is additionally disposed at a manifold portion 16 of the intake pipes 5A to 5D upstream of the gasiform and liquid fuel injectors 6A to 6D. The injector 15 allows the engine to operate only on the gasiform fuel in all rpm ranges including starting, particularly during cold starts.

With the aim of reducing cost of the fuel injection system, the inventors considered achieving the fuel injection system using the fuel injector of one type (a common injector) applicable both for the injector of liquid fuel and that of gasiform fuel, thereby reducing the number of fuel injectors used.

The fuel injection system according to the preferred embodiment of the present invention is provided with sensors for detecting the operating conditions of the internal combustion engine 1. These sensors include: a coolant temperature sensor 7; a crank angle sensor 8 detecting a speed and a crank angle of the internal combustion engine 1; a vehicle speed sensor 9 detecting the speed of an output shaft of a transmission; and an oxygen sensor 11 mounted on an exhaust pipe 10.

A controller 20 receives signals from the crank angle sensor 8 and other sensors. Based on these signals, the controller 20 controls the gasiform and liquid fuel injectors 6A to 6D, an ignition coil 12, the fuel pump 31, and the like.

FIG. 4 is a block diagram showing an internal construction of the controller 20. The controller 20 is made up of a computer including an input circuit 191, an analog/digital converter 192, a CPU 193, a ROM 194, a RAM 195, and an output circuit 196. The input circuit 191 receives signals from various sensors (e.g., the coolant temperature sensor 7 and the throttle position sensor 13 for analog signals), removes noise components from the signals and performs other operations, and then outputs resultant signals to the analog/digital converter 192. The CPU 193 reads the results of conversion made by the analog/digital converter 192 and executes a fuel injection control program and other control programs stored in the ROM 194 and other storage media. The CPU 193 thereby performs functions of executing the aforementioned controls and diagnostics procedures. The calculations performed by the CPU 193 and those of analog-to-digital conversion are temporarily stored in the RAM 195. At the same time, these calculations are output as a control output signal 197 through the output circuit 196 for use in controlling the gasiform and liquid fuel injectors 6A to 6D, the ignition coil 12, and the like.

The arrangement using only the common injector will be described in the following in terms of the typical operation thereof.

The liquid fuel injection device and the gasiform fuel injection device are used as follows: During starting, especially at cold starts, the liquid fuel injection device is used. A condition is previously established for switching from the liquid fuel injection device to the gasiform fuel injection device. Such a condition may be an individual one, such as an engine condition, or more specifically, a period of time elapsed after starting or a coolant temperature, or a combination of these individual conditions. The gasiform fuel injection device is then selected when such a condition is met. FIG. 5 shows a typical operation of the liquid fuel injection device and the gasiform fuel injection device as selected under specific conditions. For example, when condition A is met during starting, the liquid fuel injection device is selected and gasoline is injected into the internal combustion engine 1. When condition B is met, the injection of gasoline is stopped and, instead, the gasiform fuel is injected into the internal combustion engine 1.

The selection of the appropriate fuel injection device will be described in greater detail. FIG. 6 shows a control method employed for counteracting torque change and fluctuation and preventing hunting at a time of fuel change. In FIG. 6, gasoline is used as the liquid fuel and CNG is used as the gasiform fuel.

When gasoline is switched to CNG, torque drops by about 10% due to the reduced filling efficiency of the gasiform fuel with a constant throttle position and at the stoichiometric air fuel ratio. To eliminate this torque change, the throttle is opened so as to increase torque by 10% and make the amount of air greater than that before gasoline is switched to CNG. In addition, CNG is injected in synchronism with the varying throttle position in a stepwise fashion from 0 to 100%, while keeping an increment of 10%. If a torque reaction results from this increased quantity of CNG injected, ignition timing is controlled to an advanced side.

Similarly, when CNG is switched to gasoline, torque increases by about 10% with a constant throttle position and at the stoichiometric air fuel ratio. To eliminate this torque change, the throttle is closed so as to decrease torque by 10% and make the amount of air smaller than that before CNG is switched to gasoline. In addition, gasoline is injected in synchronism with the varying throttle position in a stepwise fashion from 0 to 100% by decrements of 10%. If a torque reaction results from this decreased quantity of gasoline injected, the ignition timing is controlled to a retarded side.

FIG. 7 is a control block diagram for ensuring that an exact quantity of fuel required for combustion is injected with great accuracy of sharing between the liquid fuel and the gasiform fuel. Reference numeral 200 represents basic injection quantity calculation means. A basic injection quantity Ti is calculated using an air quantity (Qa), an engine speed (Ne), and the like. Reference numeral 201 represents liquid fuel injection quantity calculation means. The liquid fuel injection quantity is calculated by multiplying the basic injection quantity Ti by a fuel property setting coefficient Ki. Reference numeral 202 represents gasiform fuel injection quantity calculation means. The gasiform fuel injection quantity is calculated by multiplying the basic injection quantity Ti by a gas property setting coefficient Kg. Fuel injection quantity sharing means 203 uses liquid fuel injection counting means 206 to monitor the number of times liquid fuel injection is performed for each cylinder. Based on a signal representing the results of this monitoring, the fuel injection quantity sharing means 203 calculates the gasiform fuel injection quantity. Injection command means 207 issues a command for stopping or executing liquid fuel injection or gasiform fuel injection under the conditions shown in FIG. 5. Reference numerals 204 and 205 represent output means.

Preferred modes for carrying out the present invention will be described in the following.

According to a first mode for carrying out the invention, a fuel injector of single type is used commonly as the gasiform fuel injector and the liquid fuel injector. This makes it possible to integrate injectors of two types provided one for the gasiform fuel and one for the liquid fuel conventionally mounted individually for each cylinder into injectors of single type. At the same time, the fuel gallery can be integrated into one type.

According to a second mode for carrying out the invention, the supply of the gasiform fuel or the liquid fuel is selected in accordance with the engine operating range, or the engine speed.

According to a third mode for carrying out the invention, one injector dedicated to injection of the gasiform fuel is added to the common injector injecting both gasiform fuel and liquid fuel. The injector dedicated to injection of the gasiform fuel is disposed at the manifold portion before branching into the intake pipes upstream of the common injector. The addition of the gasiform fuel-dedicated injector supplements a short supply of gasiform fuel supplied from the common injector, thus enabling operation only on the gasiform fuel in the entire operating range of the engine, that is, the entire speed ranges including that of engine starting.

This expands the operating range using as the supply fuel the gasiform fuel, or specifically in this case, the CNG fuel that emits smaller amounts of NOx, HC, CO, and other emissions than the liquid fuel, or specifically in this case, the gasoline fuel. This contributes to an even further reduction in exhaust emissions.

According to a fourth mode for carrying out the invention, the gasiform fuel-dedicated injector is made to inject the liquid fuel for removing deposits generated at an orifice portion of the gasiform fuel-dedicated injector while the liquid fuel is being used. This cleaning injection helps enhance reliability of the entire system.

According to a fifth mode for carrying out the invention, timing for the cleaning injection is set to the time of starting or the range at which the throttle valve fully opens.

According to these preferred embodiments of the present invention, the torque change and fluctuation occurring at the changeover of the fuel can be prevented, which contributes to the improved driveability of the vehicle. The use of the common injector injecting both gasiform fuel and liquid fuel reduces the number of fuel injectors and fuel galleries to half for the reduced parts cost, as compared with the conventional system using two fuel injection devices for a single internal combustion engine.

According to still other embodiments of the present invention, the degree of freedom in the injector mounting position is increased and assemblability increased. Since the common injector can clean during liquid fuel injection deposits accumulated at the orifice portion during gasiform fuel injection, reliability of the injector is also enhanced.

According to further embodiments of the present invention, the addition of one gasiform fuel-dedicated injector to the system using the common injector allows the entire operating range of the vehicle to be covered even with the gasiform fuel only. This makes possible a further reduction in exhaust emissions of NOx, HC, CO, and the like.

As described in the foregoing, according to the present invention, driveability of the vehicle is enhanced since the torque change and fluctuation occurring at the changeover of the fuel can be prevented. In addition, the use of the injector commonly used for injecting the gasiform fuel and the liquid fuel reduces the numbers of fuel injectors and fuel galleries half those of the conventional system having two fuel injection devices for a single internal combustion engine. This reduces parts cost.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A method for controlling fuel injection in a bi-fuel internal combustion engine operating on at least one of a gasiform fuel and a liquid fuel, comprising the step of:
providing control of correcting a fuel injection quantity, an intake air quantity, or ignition timing when operation of said bi-fuel internal combustion engine is switched from the operation on said liquid fuel to that on said gasiform fuel, or vice versa.

2. The method for controlling fuel injection in a bi-fuel internal combustion engine according to claim 1, wherein a combined control of correcting the fuel injection quantity and the intake air quantity is provided when the operation of said bi-fuel internal combustion engine is switched from the operation on said liquid fuel to that on said gasiform fuel, or vice versa.

3. The method for controlling fuel injection in a bi-fuel internal combustion engine according to claim 1, wherein a combined control of correcting the fuel injection quantity, the intake air quantity, and the ignition timing is provided when the operation of said bi-fuel internal combustion engine is switched from the operation on said liquid fuel to that on said gasiform fuel, or vice versa.

4. A device for controlling fuel injection in a bi-fuel internal combustion engine, wherein a fuel injector is used commonly for injecting a gasiform fuel and a liquid fuel.

5. The device for controlling fuel injection in a bi-fuel internal combustion engine according to claim 4, wherein supply of the gasiform fuel or the liquid fuel is selected in accordance with an engine operating condition.

6. The device for controlling fuel injection in a bi-fuel internal combustion engine according to claim 4, wherein an injector dedicated to injection of the gasiform fuel is added to said common injector injecting both gasiform fuel and liquid fuel.

7. A device for controlling fuel injection in a bi-fuel internal combustion engine, said device being provided with a first fuel injector injecting a liquid fuel and a second fuel injector injecting a gasiform fuel,
wherein said liquid fuel injected from said first fuel injector is used for performing a cleaning injection for cleaning said injector dedicated to injection of the gasiform fuel.

8. The device for controlling fuel injection in a bi-fuel internal combustion engine according to claim 7,
wherein timing for performing said cleaning injection for cleaning with said liquid fuel said injector dedicated to injection of the gasiform fuel is set to a time of starting or a range at which a throttle valve fully opens.
